(19) United States
(12) Patent Application Publication
(10) Pub. No.: US 2006/0037565 A1
(43) Pub. Date: Feb. 23, 2006

(54) Vehicle mounted filter assembly for entrapment of ambient air pollutants

(76) Inventor: George J. Coates, Wall, NJ (US)

Correspondence Address: CLIFFORD G. FRAYNE, 136 DRUM POINT RD, SUITE 7A, BRICK, NJ, 08723, US

(21) Appl. No.: 11/199,704

(22) Filed: Aug. 10, 2005

Related U.S. Application Data
(60) Provisional application No. 60/602,123, filed on Aug. 18, 2004.

(51) Int. Cl. F01P 7/10; F02M 35/02

(52) U.S. Cl. 123/41.49; 123/198 E

(57) ABSTRACT

A vehicle mounted filter assembly for entrapment of air pollutants, the filter assembly including a bracket mounted to the vehicle forward of the radiator assembly, or behind the radiator, the bracket having two opposed vertical channels for the slidable receipt of a filter assembly having a filter medium of charcoal, gauze or ionic attraction, the filter being slidably removable from the bracket for discard and a new filter inserted, this interchange occurring on a regular service basis.

### RELATED APPLICATIONS

Applicant claims the benefit of provisional application Ser. No. 60/602,123 filed Aug. 18, 2004.

### BACKGROUND OF THE INVENTION

1. Field of the Invention

The present invention relates to a filter assembly and more particularly to a filter assembly which could be mounted on a vehicle in the air flow path through the front radiator and serve to entrap air pollutants, the filter assembly being discardable upon exhaustion and replaceable.

2. Description of the Prior Art

Environmental awareness has educated people to the need for eliminating or severely reducing pollution of our atmosphere. Depletion of the ozone layer is a serious concern as well as the particularly pollution of the atmosphere. One of the most prevalent polluters is the internal combustion engine which is utilized in vehicles in every country of the world. Some countries have taken steps to reduce the pollutants emanating from an internal combustion engine, such as the use of catalytic converters mandated in the United States. Nevertheless, the internal combustion engine continues to be a primary source of pollution of the atmosphere.

Applicant's assembly would be utilized to decrease the amount of particulate pollution in the atmosphere by having a vehicle fitted with an internal combustion engine which produces much of the pollutant, also serve as a mobile filter means to at least partially remove particulate pollutants from the atmosphere.

### OBJECTS OF THE INVENTION

An object of the present invention is to provide for a novel filter assembly which would be mounted on a vehicle and which would collect pollutants in the atmosphere during operation of the vehicle.

A further object of the present invention is to provide for a novel filter assembly to be mounted on a vehicle forward of the radiator assembly or behind the radiator fan which filter assembly would collect air born pollutants during operation of the vehicle.

A still further object of the present invention is to provide for a novel filter assembly which would be removably secured proximate the front of an internal combustion engine vehicle which filter assembly would be of low cost and could be removed and discarded and replaced on a regular basis.

A still further object of the present invention is to provide for a novel filter assembly mounted on a vehicle which would serve to collect air born pollutants and small particulate matter whenever the vehicle was operating.

A still further object of the present invention is to provide a novel filter assembly mounted on a vehicle to serve to collect air born pollutants and particulate matter which would not inhibit the cooling efficacy of the radiator.

### SUMMARY OF THE INVENTION

A vehicle mounted filter assembly for entrapment of air pollutants, the filter assembly including a bracket mounted to the vehicle forward of the radiator assembly, or behind the radiator, the bracket having two opposed vertical channels for the slidable receipt of a filter assembly having a filter medium of charcoal, gauze or ionic attraction, the filter being slidably removable from the bracket for discard and a new filter inserted, this interchange occurring on a regular service basis.

### BRIEF DESCRIPTION OF THE DRAWINGS

These and other advantages and improvements will be evident, especially when taken in light of the following illustrations wherein:

FIG. 1 is a front view of a radiator assembly for an internal combustion engine and a first embodiment of the filter assembly of the present invention;

FIG. 2 is a top view of a radiator assembly and the filter assembly of the first embodiment of the present invention;

FIG. 3 is a top view of one embodiment of the filter media of the present invention; and

FIG. 4 is a top view of a radiator assembly and a second embodiment of the present invention.

### DETAILED DESCRIPTION OF THE INVENTION

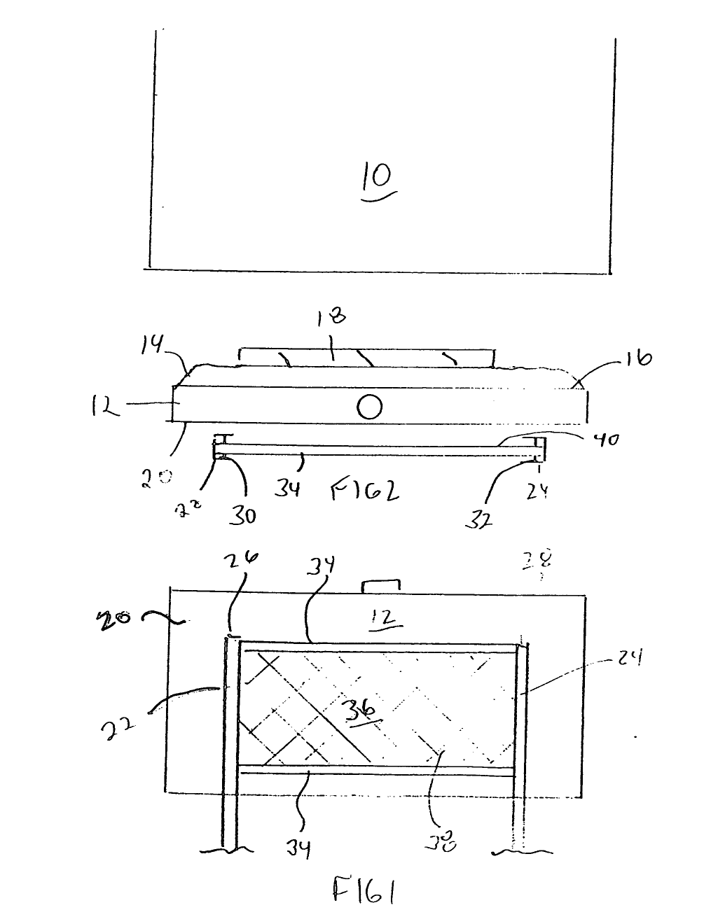

The primary application of Applicant's vehicle mounted filter assembly for the entrapment of pollutants would be on a vehicle which has a forward mounted engine and radiator assembly. FIG. 1 is a front view of such an assembly and FIG. 2 is a top view of such an assembly. The engine 10 is mounted forwardly of the passenger compartment and is a water cooled engine. As such, mounted forwardly of the engine is a radiator 12 for controlling temperature of the coolant used to maintain the proper engine temperature. Radiator 12 normally has associated with it a cowling 14 on its rearward face 16 which cowling 14 partially encapsulates the outer circumference of a fan member 18, fan member 18 being driven off of the crank shaft of the engine 10 by means of a pulley and belt system or electrically powered (not shown).

In operation, with the vehicle in motion, the fan member 18 serves to draw air through the radiator in order to maintain the proper temperature of the coolant circulating through the radiator and the engine block. The ambient air enters the front face 20 of the radiator 12 at ambient temperature and exits the fan at a higher temperature having been heated through the heat exchange aspects of the radiator by the hot coolant circulating therein. In some modes of operation, such as high speed, the speed of the vehicle is sufficient to draw sufficient air through the radiator to effectuate such cooling. However, many times the vehicle finds itself operating at low speeds or at a stop in which case the fan provides the impetus for the air flow. Indeed some vehicles are equipped with multi-speed fans and sensors to sense when fan operation is necessary and when it is not.

In Applicant's invention a bracket assembly would be secured to the frame of the vehicle forward of the front face 20 of the radiator 12. In the embodiment illustrated in FIGS. 1 and 2, this bracket assembly would consist of two vertical C-shaped channels 22 and 24, the C-shaped channels 22 and 24 being open at their upper ends 26 and 28 and having a end wall at the lower ends 30 and 32. The brackets would be positioned several inches in front of the front face 20 of the radiator 12 and be spaced apart a sufficient distance to allow for the slidable insertion therein of a filter medium as described in detail hereafter. In the embodiment illustrated in FIGS. 1 and 2, the bracket assembly is positioned such that it is not coextensive with the front face 20 of the radiator 12.

The filter medium slidably receivable within the bracket assembly between vertical C-shaped brackets 22 and 24 and would consist of a rigid or semi-rigid frame member 34 defining a periphery within which a filter medium 36 would be positioned. The filter medium could consist of a front outer mesh 38 and a rear outer mesh 40 of a mesh size sufficient to allow the passage of air there being disposed there between, the filter medium 36 would be comprised of a suitable filter composition including either granulated charcoal, gauze, fabric or the like, or a mixture of both. The filter medium could also include a grid of metallic filaments in communication with the electrical system of the vehicle in order to achieve ionic deposition of charged particulate matter.

In this configuration, as the vehicle operates in a forward motion, the air being utilized to cool the radiator coolant first encounters the filter medium 36 which is of such a density so as to not interfere with the normal air flow to the radiator but is of a density sufficient to remove small harmful particulate pollutant matter in the ambient air which passes there through. In this configuration, the vehicle on which the filter assembly is installed would serve to clean the air by entrapping particulate pollutants when the vehicle engine was in operation. If one were to multiply the effective surface area of the filter assembly as illustrated in FIG. 1 by similar filter assemblies installed on all other vehicles on the road at a particular time and one can realize that while the internal combustion engine associated with an automobile is one of the most serious polluters of the atmosphere, a configuration as illustrated would have a significant impact on removing particulate pollutants. The design and construction of the filter medium 36 would be such that its life expectancy would coextensive with the regular servicing of the vehicle. For example, the filter medium 36 could have a life expectancy of 5,000 miles and therefore coincide with a normal and regular oil change for the vehicle and could thus be removed, disposed of and replaced at the same servicing or depending upon the filter medium, regenerated.

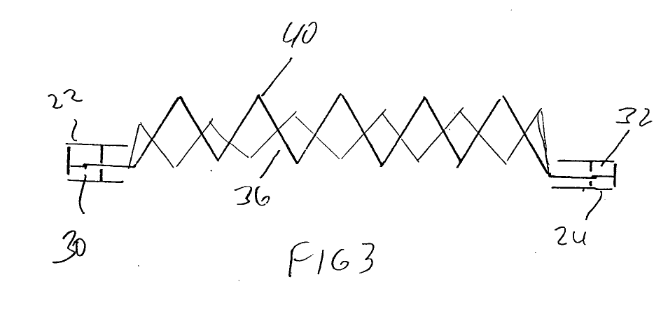

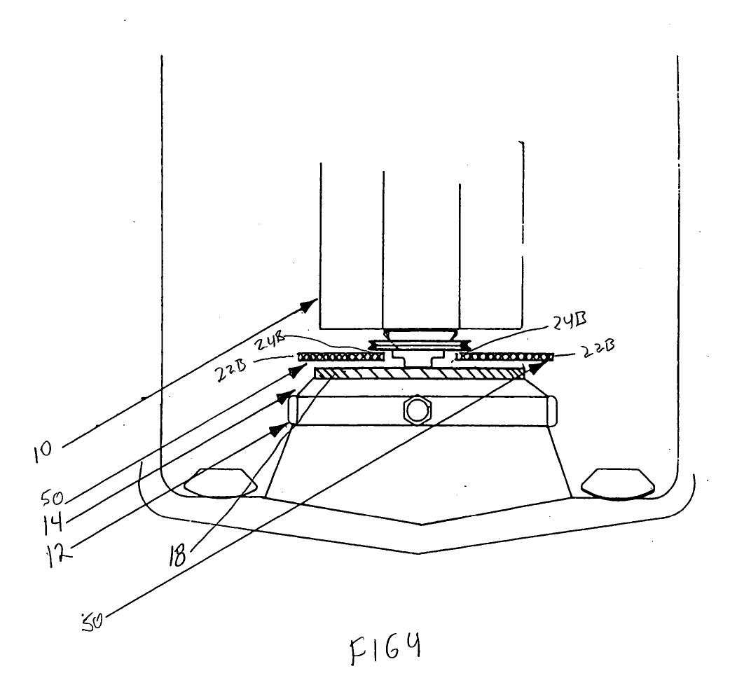

The effective surface area of the filter medium 36 could be increased over that which is shown in FIG. 1 by producing the filter medium with a corrugated or honeycombed frame 40 design as illustrated in FIG. 3 in which the filter medium 36 and bracket assembly would take up slightly more front to back space in front of the radiator member 12 but would provide for an increased surface area for the collection of particular pollutants. The frame 42 of the corrugated design of FIG. 3 may also incorporate vertical internal stiffeners (not shown) so as to provide further structural integrity.

FIG. 4 is a top view of a radiator assembly of the present invention with a second embodiment of Applicant's vehicle mounted filter assembly. In this embodiment, the filter and bracket assembly would be positioned rearwardly of the radiator 12, cowling 14, and fan member 18. In one particular design it would consist of two bracket members 50 comprised of two vertical C-shaped channels 22B and 24B, each being opened at their upper ends, and having an end wall at their lower ends for the slidable receipt of a filter medium positioned behind the radiator, but on both sides of the drive shaft which operates the fan. Each bracket member would have a separate filter medium associated therewith, the filter medium being of any of the type previously described with respect to the first embodiment of Applicant's filter assembly.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. A vehicular mounted filter assembly for the entrapment of ambient air pollutants comprising:
a land vehicle having a motor means mounted to a chassis for propulsion of said vehicle, said vehicle having an air flow path from an ambient atmosphere through a body grill to an air intake manifold on said motor, said air flow path including a motor air filter positioned prior to said air intake manifold;
an ambient air filter assembly mounted in said air flow path between said body grill and said motor air filter of said vehicles, said ambient air filter assembly comprising a frame member mounted to said chassis of said vehicle, said frame member for receipt of a filter medium for the passage therethrough of a portion of the ambient air drawn through said grill en route to said motor air filter and said air intake manifold, said filter medium for the collection of particular matter in the ambient air when said motor is operating.

2. The vehicular mounted filter assembly for entrapment of ambient air in accordance with claim 1 wherein said frame member comprises spaced apart vertical members U-shaped in cross sectional area secured to a bottom cross member, said U-shaped spaced apart vertical members facing each other to define a slot for the slidable receipt of said filter medium.

3. The vehicular mounted filter assembly for the entrapment of ambient air pollutants in accordance with claim 1 wherein said filter medium comprises a filter medium frame having opposing side walls, a top wall member, and a bottom wall member, said filter medium having disposed thereon a front mesh face and a rear mesh face.

4. The vehicular mounted filter assembly for entrapment of ambient air pollutants in accordance with claim 3 wherein said filter medium comprises granulated charcoal.

5. The vehicular mounted filter assembly for entrapment of ambient air pollutants in accordance with claim 3 wherein said filter medium comprises fabric.

6. The vehicular mounted filter assembly for entrapment of ambient air pollutants in accordance with claim 3 wherein said filter medium comprises gauze.

7. The vehicular mounted filter assembly for entrapment of ambient air pollutants in accordance with claim 3 wherein said filter medium comprises paper.

8. The vehicular mounted filter assembly for entrapment of ambient air pollutants in accordance with claim 3 wherein said filter medium comprises a combination of granular charcoal, fabric, gauze, and paper.

9. The vehicular mounted filter assembly for entrapment of ambient air pollutants in accordance with claim 3 wherein said filter medium comprises a grid of metallic elements connected to an electrical system of said land vehicle for the entrapment of ambient air pollutants by means of ionic deposition.

10. The vehicular mounted filter assembly for entrapment of ambient air pollutants in accordance with claim 2 wherein said filter medium is slidably removable for disposable and replacement from said frame member.

11. The vehicular mounted filter assembly for entrapment of ambient air pollutants in accordance with claim 3 wherein said filter medium are regenerable.

12. The vehicular mounted filter assembly for entrapment of ambient air pollutants in accordance with claim 1 wherein said filter assembly is mounted forward of said radiator.

13. The vehicular mounted filter assembly for entrapment of ambient air pollutants in accordance with claim 1 wherein said filter assembly is mounted rearward of said radiator.
